(19) United States
(12) Patent Application Publication
(10) Pub. No.: US 2018/0040902 A1
(43) Pub. Date: Feb. 8, 2018

(54) ELECTRODE CURRENT COLLECTOR DESIGN IN A BATTERY

(71) Applicant: Pacesetter, Inc., Sunnyvale, CA (US)

(72) Inventors: Xiaofei Jiang, Clemson, SC (US); Russell Bruch, Greenville, SC (US)

(21) Appl. No.: 15/649,270

(22) Filed: Jul. 13, 2017

Related U.S. Application Data
(60) Provisional application No. 62/371,002, filed on Aug. 4, 2016.

(51) Int. Cl. H01M 4/74; H01M 4/36; H01M 4/66

(52) U.S. Cl. CPC H01M 4/74; H01M 4/667; H01M 4/366; H01M 2300/0065; H01M 2300/0002

(57) ABSTRACT

A battery includes an anode, an electrolyte, and a cathode. The cathode includes a current collector formed from a mesh structure with an opening pattern. The opening pattern does not include any angles less than 90 degrees, and the current collector has a first surface and a second surface opposite the first surface. The cathode also includes a first material layer bonded to the first surface of the current collector, and a second material layer bonded to the second surface of the current collector and to the first material layer through the current collector.

### PRIORITY CLAIM

The present application relates to and claims priority from U.S. provisional application Ser. No. 62/371,002, filed Aug. 4, 2016, entitled “Method Of Printing A Conductive Ink Onto A Cathode Surface To Increase Surface Area And Capacitance,” which is hereby expressly incorporated by reference in its entirety to provide continuity of disclosure.

### FIELD

The present systems and methods relate to the design and method of making batteries for use within implantable medical devices.

### BACKGROUND

Batteries with high energy density and high discharge rate capabilities are desirable for certain applications. This is especially true when the batteries are used in devices where the batteries are difficult to replace and/or recharge, such as in an implantable medical device (IMD). An end-of-life (EOL) indicator for the battery may also be an important feature for this kind of application.

The performance of high energy density and high discharge rate batteries used in implantable medical devices (IMD) such as the lithium silver vanadium oxide (SVO) batteries is greatly affected by the cathode current collector material and mechanical design. The collector material needs to be chemically and electrochemically stable against the cathode material and battery electrolyte at the potential at which the cell is designed to operate. The collector design needs to promote good electrode integrity, reduce electrical resistivity and offer high packaging efficiency.

### SUMMARY

Embodiments of a device battery, and methods for fabricating the battery are described herein.

In an embodiment, a battery electrode includes a current collector formed from a mesh structure with an opening pattern. The opening pattern does not include any angles less than 90 degrees, and the current collector has a first surface and a second surface opposite the first surface. The electrode also includes a first material layer bonded to the first surface of the current collector, and a second material layer bonded to the second surface of the current collector and to the first material layer through the current collector.

In another embodiment, a battery includes an anode, an electrolyte, and a cathode. The cathode includes a current collector, a first material layer and a second material layer as described in the embodiment above.

### BRIEF DESCRIPTION OF THE FIGURES

The accompanying drawings, which are incorporated herein and form part of the specification, illustrate the devices and methods presented herein. Together with the detailed description, the drawings further serve to explain the principles of, and to enable a person skilled in the relevant art(s) to make and use, the methods and systems presented herein.

In the drawings, like reference numbers indicate identical or functionally similar elements. Further, the drawing in which an element first appears is typically indicated by the leftmost digit(s) in the corresponding reference number.

FIG. 1 illustrates a common battery configuration.

FIG. 2 illustrates a battery configuration, according to an embodiment.

FIGS. 3A-3D are views of various current collector configurations, according to some embodiments.

FIG. 4 is a side-view of a cathode, according to an embodiment.

FIG. 5 is a graph of equivalent thickness versus percentage of mesh opening.

FIG. 6 is a graph of pre-pulse voltage and charge time versus battery capacity for various current collector designs.

### DETAILED DESCRIPTION

The following detailed description of the devices and methods refers to the accompanying drawings that illustrate exemplary embodiments consistent with these devices and methods. Other embodiments are possible, and modifications may be made to the embodiments within the spirit and scope of the methods and systems presented herein. Therefore, the following detailed description is not meant to limit the methods and systems described herein. Rather, the scope of these methods and systems is defined by the appended claims.

### Exemplary Environment

Before describing in detail the design and method of making electrodes of a battery, it is helpful to describe an example environment in which such a battery may be implemented. The battery embodiments described herein may be particularly useful in the environment of an implantable medical device (IMD) such as an implantable cardiac device, e.g., an implantable cardioverter defibrillator (ICD). Examples of such ICDs may be found in U.S. Pat. Nos. 6,327,498 and 6,535,762, each of which is incorporated herein by reference.

### Battery Design

An ICD, such as those described in the patents identified above, requires some form of power source in order to operate. A primary lithium battery may be used to provide a high current output power source.

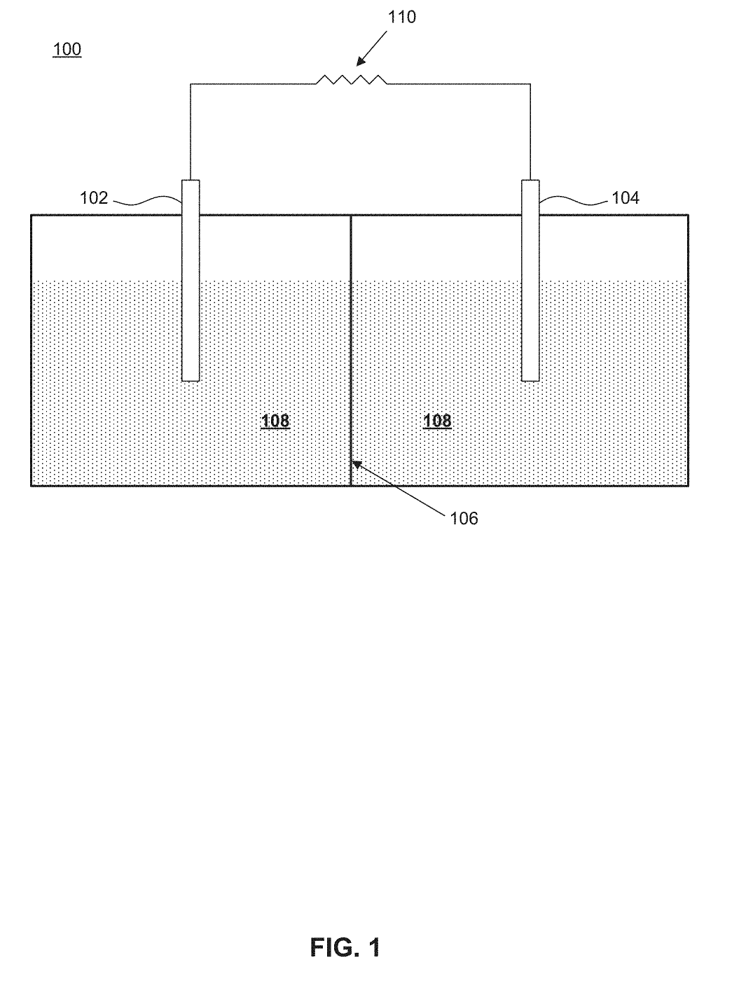

FIG. 1 illustrates an example design for a battery 100. Battery 100 includes a cathode 102, an anode 104 separated from the anode via a separator 106, and some form of electrolyte 108 in contact with anode 104 and cathode 102. The various battery elements illustrated in FIG. 1 are provided for representative purposes only and are not intended to limit the structural design of the battery embodiments herein.

Separator 106 may be configured such that ions may pass through separator 106 between anode 104 and cathode 102. An example of separator 106 includes a polyethylene film. Electrolyte 108 may be in liquid form or as a solid or semi-solid polymer in contact with anode 104 and cathode 102.

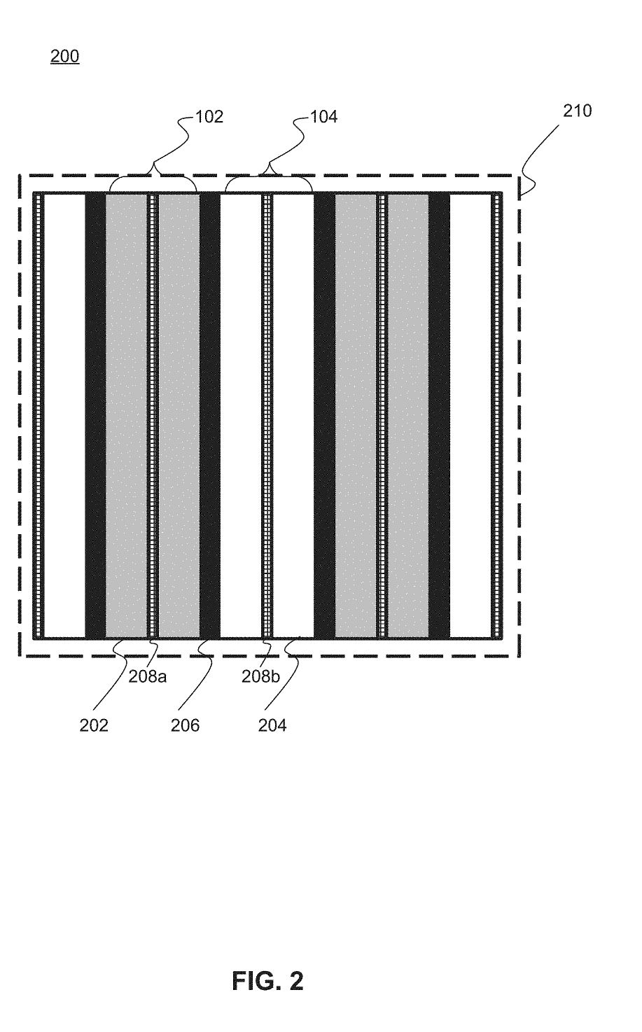

Each of anode 104 and cathode 102 may include some active material bonded to a current collector (see FIG. 2). The active materials take part in the electrochemical reaction to produce the current, while the current collectors are conductive materials that provide a low-resistance path for the current to flow. For example, anode 104 may include a lithium foil bonded to a current collector, while cathode 102 may include some metal oxide material (such as silver vanadium oxide) mixed with other additives (such as carbon black or graphite) and a binder material (such as polyvinylidene difluoride (PVDF) or polytetrafluoroethylene (PTFE)) and bonded to a current collector. These types of materials may be used to make a lithium battery.

The current from battery 100 is typically delivered to a load 110. The size of load 110 affects the amount of current that flows between anode 104 and cathode 102.

FIG. 2 illustrates another example design for a battery 200, according to an embodiment. Battery 200 includes a stacked structure of alternating cathode material 202 and anode material 204, separated by a separator 206. Each layer of cathode material 202 is bonded to a cathode current collector 208a, while each layer of anode material 204 is bonded to an anode current collector 208b. The stacked layers are enclosed within a housing 210. Although not explicitly shown in FIG. 2, an electrolyte would also exist around cathode material 202 and anode material 204 to facilitate the ion transport between the anode and cathode materials. The electrolyte may be a polymer or liquid electrolyte as would be understood to one skilled in the art. Examples of the electrolyte include lithium bis-trifluoromethanesulfonimide (LiTFSI) in propylene carbonate/dimethoxyethane or Lithium hexafluoroarsenate (LiAsF₆) in propylene carbonate/dimethoxyethane. The stacked combination of cathode material 202 and cathode current collector 208a constitutes a cathode 102 of battery 200 while the stacked combination of anode material 204 and anode current collector 208b constitutes an anode 104 of battery 200.

Cathode current collectors 208a may be electrically connected together to form the positive terminal of battery 200 (cathode), while anode current collectors 208b may be connected together to form the negative terminal of battery 200 (anode). In one embodiment, anode material 204 comprises a lithium foil, and cathode material 202 comprises a metal oxide material. Separator 206 may be polyethylene. A typical battery 200 for use in an ICD using lithium anode material 204 and silver vanadium oxide cathode material 202 has an operating open circuit voltage (OCV) between 3.25 and 2.35 V with a cathode capacity of 315 mAh/g, for example.

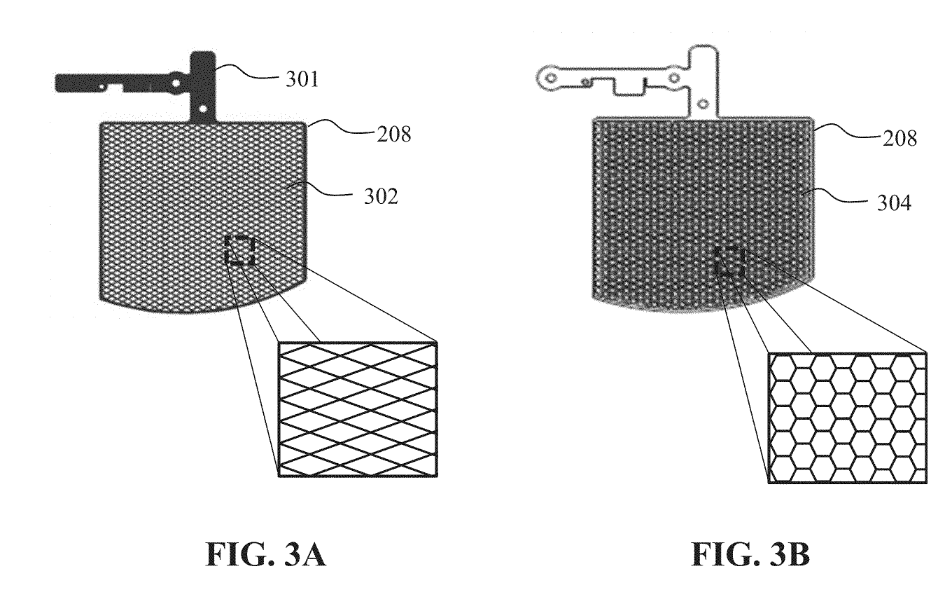

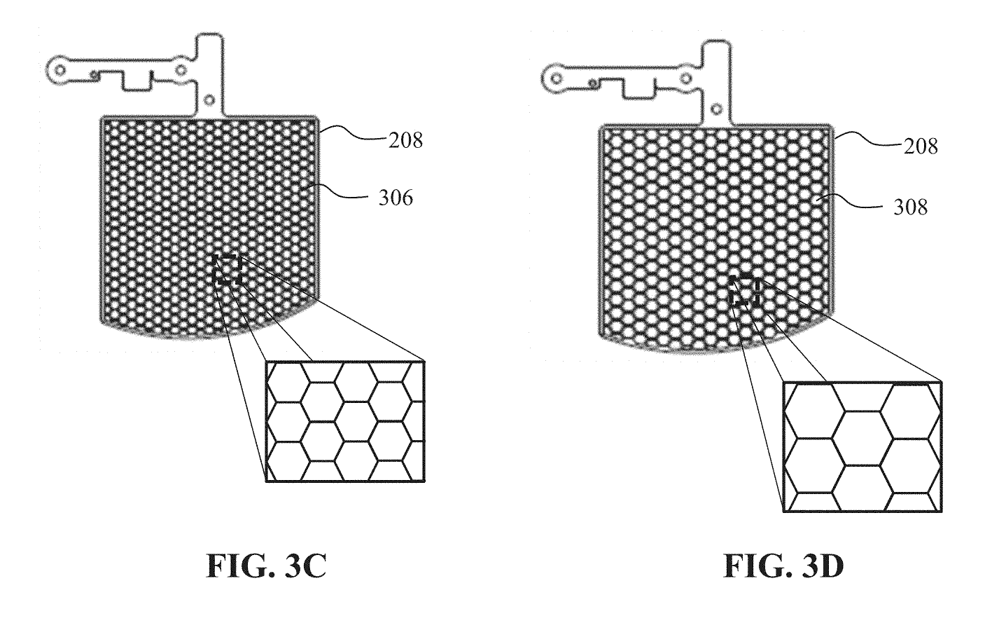

FIG. 3A illustrates a current collector 208 formed from a mesh structure 302. Current collector 208 also includes a tab 301 that makes conductive contact with current collector 208 and provides a structure for electrical connections to be made. In one example, tab 301 is welded to current collector 208.

Mesh structure 302 allows for material layers to be placed on either side of current collector 208 and to be bonded both to the mesh structure, and to each other through the openings of the mesh structure. Current collector 208 may be used as part of either an anode or cathode of a battery depending on the composition of the material layers bound to current collector 208. In this current collector design, mesh structure 302 has a diamond-like repeating pattern as illustrated in the blown up portion of the figure. The use of the diamond pattern may result in about 47% of the surface area of mesh structure 302 being open, for example. However, the diamond pattern includes sharp angles (i.e., angles less than 90 degrees.) These acute angles can create a narrow path for the material layers to protrude through the openings in mesh structure 302 and bond to each other causing incomplete filling of the openings through current collector 208, thus raising the overall resistance of the electrode.

FIG. 3B illustrates another current collector 208 having a mesh structure 304, according to an embodiment. Mesh structure 304 includes an opening pattern (i.e., a pattern of openings such as a honeycomb pattern) that does not include any angles less than 90 degrees. It should be understood that the opening pattern having angles all equal to or greater than 90 degrees does apply to those patterns directly along edges of current collector 208, as these patterns along the edges are often cut off at angles that may form acute corners. In one example, mesh structure 304 includes a repeating hexagonal pattern as illustrated in the blown up portion. The hexagonal pattern may result in about 57% of the surface area of mesh structure 304 being open, for example. By using a pattern that does not include any acute angles, the material layers bound to either side of mesh structure 304 can bond together more easily through the openings in mesh structure 304, thus strengthening the integrity of the electrode. Additionally, the higher opening percentage (i.e., the percentage of the surface area of the mesh structure that is represented by open space as compared to solid material) across the surface area of mesh structure 304 reduces the weight and volume of current collector 208. The reduced weight/volume may increase the total cell packing efficiency of the battery.

The repeating hexagonal pattern of mesh structure 304 may include hexagons that have a width between about 0.030 inches and 0.040 inches. Other shapes such rectangles, squares, pentagons, octagons, circles, or ovals may be used as well with similar dimensions.

FIG. 3C illustrates another current collector 208 having a mesh structure 306, according to an embodiment. Mesh structure 306 includes larger openings than mesh structure 304, and may have a total percentage opening of about 65% across the surface area of mesh structure 306, for example. Mesh structure 306 may also include a repeating hexagonal pattern as illustrated in the blown up portion of the figure. The repeating hexagonal pattern of mesh structure 306 may include hexagons that have a width between about 0.045 inches and 0.055 inches. Other shapes such as rectangles, squares, pentagons, octagons, circles, or ovals may be used as well with similar dimensions.

FIG. 3D illustrates another current collector 208 having a mesh structure 308, according to an embodiment. Mesh structure 308 includes larger openings than mesh structure 304 or mesh structure 306, and may have a total percentage opening of about 70% across the surface area of mesh structure 308, for example. Mesh structure 308 may also include a repeating hexagonal pattern as illustrated in the blown up portion of the figure. The repeating hexagonal pattern of mesh structure 308 may include hexagons that have a width between about 0.060 inches and 0.070 inches. Other shapes such as rectangles, squares, pentagons, octagons, circles, or ovals may be used as well with similar dimensions.

According to an embodiment, current collector 208 and its associated mesh structure 304/306/308 are machined, cast, stamped, forged, or otherwise formed from a metal such as aluminum, stainless steel, or titanium, to name a few example materials. A conductive coating, such as carbon coating, may also be applied to the surface of mesh structure 304/306/308 to further promote binding strength and conductivity. Current collector 208 may have a total thickness between about 0.001 inches and 0.005 inches, for example.

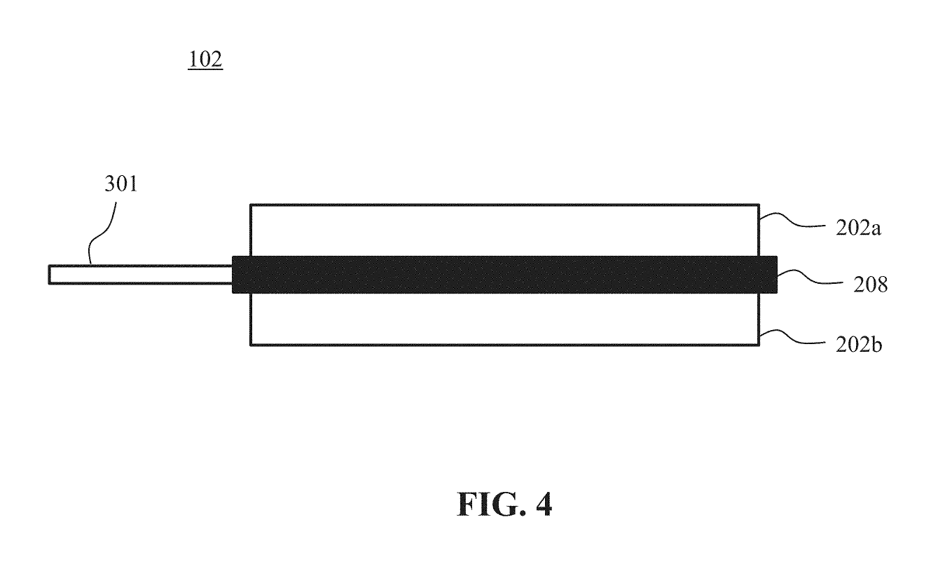

FIG. 4 illustrates an example side view of cathode 102 that includes current collector 208 flanked on both sides by cathode material layer 202a and cathode material layer 202b, according to an embodiment. Tab 301 also makes electrical contact with current collector 208. Cathode material layer 202a and cathode material layer 202b may be substantially the same material. Cathode material layer 202a bonds to a first surface of current collector 208 (i.e., the first surface of the mesh structure), and cathode material layer 202b bonds to a second surface of the current collector 208 (i.e., the second surface of the mesh structure, opposite the first surface of the mesh structure). Cathode material layers 202a and 202b also bond to each other through the openings of the mesh structure, according to an embodiment.

Each of cathode material layer 202a and cathode material layer 202b may include a polytetrafluoroethylene (PTFE) binder with particles of silver vanadium oxide (SVO). In one example, each of cathode material layer 202a and 202b includes about 3% of PTFE, 94% SVO, and 2% of carbon black, and 1% graphite to promote better conductivity.

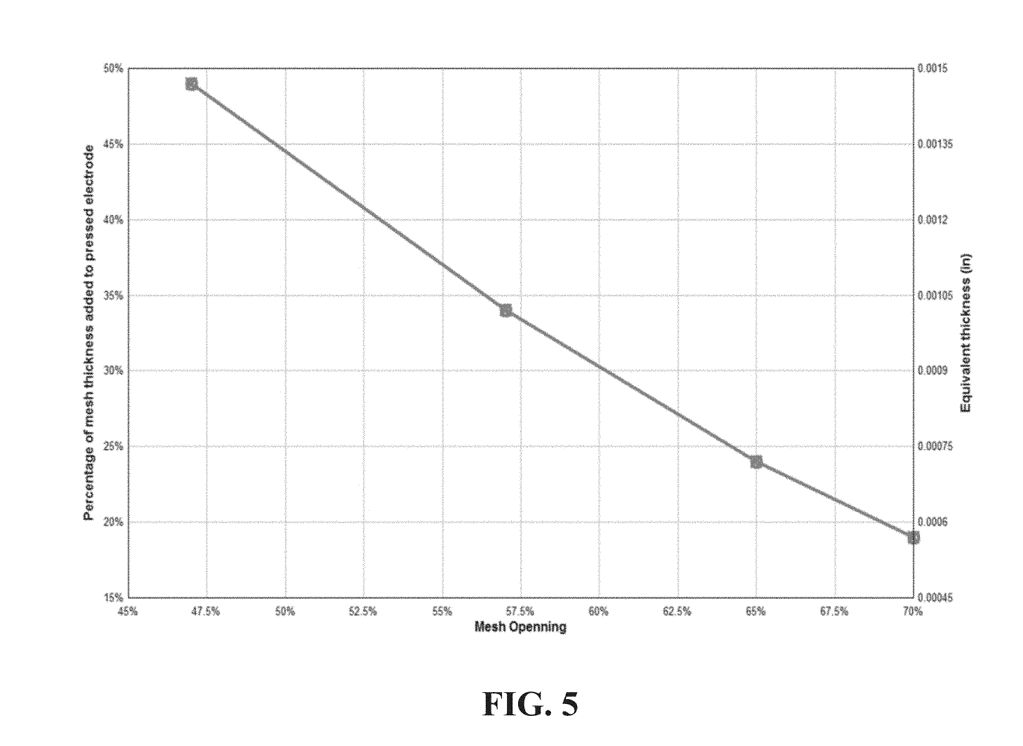

FIG. 5 is a graph showing the effects of the mesh structure thickness based on the total percentage of openings across a surface area of the mesh structure. As can be seen in the graph, a higher mesh opening percentage yields a lower overall solid mesh volume added to the pressed electrode and a lower equivalent mesh thickness. This occurs because having a higher opening percentage allows for more of the material layers to be pressed into the openings and bond across the mesh structure. Thus, a greater volume of the material can fill between the openings of the mesh structure, and the overall thickness of the electrode is reduced.

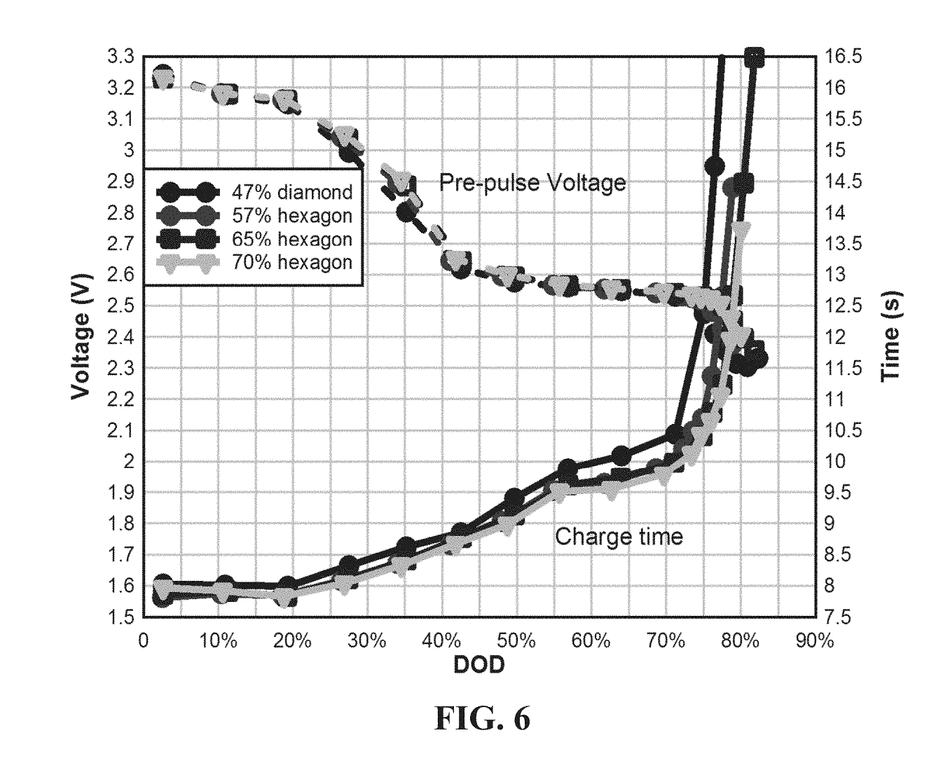

FIG. 6 is a graph showing various electrical properties of a battery made with different current collector designs compared to the depth of discharge (DOD) of the battery. To perform the testing, experimental batteries were built using different current collector designs for the SVO-based cathodes. The battery cells were tested following a three month 72 C ADD life test protocol, which involves fully discharging the cell with a high discharge rate at an elevated temperature of between 70 degrees Celsius and 75 degrees Celsius.

As can be seen from the graph in FIG. 6, the pre-pulse voltage (read along the left side of the y-axis) of the battery cells using the four different current collector designs remains roughly the same across the lifetime of the cells (up to about 80% of total discharge). Thus, the change in current collector design has no adverse effect on the pre-pulse voltage.

FIG. 6 also illustrates that the charge time (read along the right side of the y-axis) of the different cells is faster when using a higher opening percentage across the cathode current collector. The difference in charge time is more noticeable as the battery cell becomes more discharged.

### Conclusion

Exemplary embodiments of the present systems and methods have been presented. The systems and methods are not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the systems and methods herein.

Further, the purpose of the Abstract provided herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present system and method in any way.

What is claimed is:

1. An energy storage device comprising:
an anode;
an electrolyte; and
a cathode, comprising:
a current collector formed from a mesh structure with an opening pattern, wherein the opening pattern does not include any angles less than 90 degrees, the mesh structure having a first surface and a second surface opposite the first surface,
a first material layer bonded to the first surface of the current collector, and
a second material layer bonded to the second surface of the current collector and to the first material layer through the current collector.

2. The energy storage device of claim 1, wherein the anode comprises lithium.

3. The energy storage device of claim 1, wherein the opening pattern comprises at least 57% of the surface area of the current collector.

4. The energy storage device of claim 1, wherein the opening pattern comprises at least 65% of the surface area of the current collector.

5. The energy storage device of claim 1, wherein the opening pattern comprises at least 70% of the surface area of the current collector.

6. The energy storage device of claim 1, wherein the current collector is formed from titanium, stainless steel, or aluminum, and includes a conductive carbon coating.

7. The energy storage device of claim 1, wherein the current collector has a thickness of about 0.003 inches.

8. The energy storage device of claim 1, wherein the opening pattern comprises a repeating hexagonal pattern.

9. The energy storage device of claim 1, wherein the first material layer and the second material layer are the same material.

10. The energy storage device of claim 1, wherein the first material layer and the second material layer each comprises a polytetrafluoroethylene (PTFE) binder with particles of silver vanadium oxide.

11. The energy storage device of claim 1, further comprising a housing that encases the anode, the electrolyte, and the cathode.

12. An battery electrode comprising:
a current collector formed from a mesh structure with an opening pattern, wherein the opening pattern does not include any angles less than 90 degrees, the mesh having a first surface and a second surface opposite the first surface;
a first material layer bonded to the first surface of the current collector; and
a second material layer bonded to the second surface of the current collector and to the first material layer through the current collector.

13. The electrode of claim 12, wherein the opening pattern comprises at least 57% of the surface area of the current collector.

14. The electrode of claim 12, wherein the opening pattern comprises at least 65% of the surface area of the current collector.

15. The electrode of claim 12, wherein the opening pattern comprises at least 70% of the surface area of the current collector.

16. The electrode of claim 12, wherein the current collector is titanium, stainless steel, or aluminum, and includes a conductive carbon coating.

17. The electrode of claim 12, wherein the current collector has a thickness of about 0.003 inches.

18. The electrode of claim 12, wherein the opening pattern comprises a repeating hexagonal pattern.

19. The electrode of claim 12, wherein the first material layer and the second material layer are the same material.

20. The electrode of claim 12, wherein the first material layer and the second material layer each comprises a polytetrafluoroethylene (PTFE) binder with particles of silver vanadium oxide.
